(19) United States
(12) Patent Application Publication
(10) Pub. No.: US 2022/0233992 A1
(43) Pub. Date: Jul. 28, 2022

(54) FINE PARTICLE AGGREGATION METHOD AND APPARATUS

(71) Applicant: KOREA INSTITUTE OF INDUSTRIAL TECHNOLOGY, Cheonan (KR)

(72) Inventors: Hyo Soo LEE, Incheon (KR); Hai Joong LEE, Incheon (KR); Hyung Won SHIN, Incheon (KR); Hye Jin LEE, Incheon (KR)

(21) Appl. No.: 17/616,523

(22) PCT Filed: Jun. 22, 2020
(86) PCT No.: PCT/KR2020/008030

§ 371 Date: Dec. 3, 2021

(30) Foreign Application Priority Data
Jun. 28, 2019 (KR) 10-2019-0078086
Jul. 1, 2019 (KR) 10-2019-0078495

(51) Int. Cl. B01D 49/00; C02F 1/36

(52) U.S. Cl. CPC B01D 49/006; C02F 1/36

(57) ABSTRACT

According to an embodiment of the present invention, in order to perform fine particle agglomeration by outputting a low frequency sound wave and then remove fine particles, there is provided a method for fine particle agglomeration, the method including: an initial fine particle measuring step of generating fine particle measurement data including a pollution level of fine particles in a purification region and outputting the data to a sound source converting unit, by a fine particle measuring unit; a low frequency and sound pressure data extracting step of extracting a low frequency and sound pressure of a low frequency sound source stored in a storage to be used for agglomeration of fine particles, based on the fine particle measurement data, by the sound source converting unit; a sound source converting step of converting an output sound source into the low frequency sound source such that the low frequency sound source has the extracted low frequency and sound pressure data, by the sound source converting unit; and a fine particle agglomeration performing step of causing fine particles to agglomerate by receiving the low frequency sound source and outputting the low frequency sound source as a low frequency sound wave for agglomeration of fine particles, by a low frequency sound wave generating unit.

### TECHNICAL FIELD

The present invention relates to a technology for collecting fine particles or ultrafine particles such as ultrafine dust or nanoplastics which are present in air, water, or a fluid, and more specifically, to a method and an apparatus for fine particle agglomeration which perform agglomeration of ultrafine particles or fine particles by using a sound wave in a medium such as air or water.

### BACKGROUND ART

In general, fine dust is not made by a natural cause but made by an artificial cause such as combustion of fossil fuel or dust from roads or rails. Recently, particulate matter having a particle size of 0.1 μm or smaller is classified as ultrafine dust and is separately dealt with. This is because the fine dust increases the risk of causing inflammatory response, asthma, chronic bronchitis, or airway obstruction, causing respiratory system infection by hindering inactivation or removal action of bacteria in lung tissue, or even acting as an important risk factor of cardiovascular diseases such as myocardial infarction, stroke, heart rate abnormality, or sudden death.

Microplastics are manufactured to be smaller than 5 mm in size during plastic processing so as to be added to toothpaste, cleaning agents, scrubs, or the like or are formed through a breaking and crushing process of used and discarded plastic products. The microplastics have been reported to be found all over the globe such as in the deepest part of the ocean which a human can reach, in mineral water or tap water, in gills or scales of fish, or in deep sea plankton. When a toxic chemical is adsorbed on the microplastics, the microplastics can be a carrier of a toxic substance. The microplastics taken in an ocean creature can cause ileus, an eating disorder, or the like, and the microplastics accumulated in a human body can cause hormonal imbalance, immune system disorder, or the like.

In this respect, several efforts have been made at national level to reduce harm caused by fine dust, ultrafine dust, and microplastics; however, a technology that can be easily used by an individual to block ultrafine dust or microplastics from outside is not yet sufficiently developed.

Consequently, there is a demand for development of an apparatus and a method that can perform agglomeration and removal of fine dust, ultrafine dust, microplastics, or nanoplastics contained in drinking water, domestic water, or the like efficiently and harmlessly to a human body without using an expensive filter, a water treatment agent harmful to the environment, ultrasound that can be harmful to a human body, or the like.

### PRIOR ART LITERATURE

Korean Unexamined Patent Publication No. 2017-0097390

### SUMMARY OF INVENTION

### Technical Problem

In order to solve problems of the related art described above, an object of an embodiment of the invention of the present application is to provide a method and an apparatus for fine particle agglomeration which cause fine particles or ultrafine particles such as fine dust, ultrafine dust, microplastics, or nanoplastics in a medium to vibrate, collide, and agglomerate by receiving a sound source (non-compressed format) or a sound reproduction means (compressed format) signal, converting the sound source or the signal into a low frequency sound source within a range of acoustic wave which is difficult for a user to feel, then reproducing the low frequency sound source, and outputting a low frequency sound wave into the medium.

In addition, to solve problems of the related art described above, another object of an embodiment of the invention of the present application is to provide an apparatus and a method for fine particle agglomeration and removal which generate a low frequency sound wave in a fluid (medium) to enable fine particles or ultrafine particles such as fine dust, ultrafine dust, microplastics, or nanoplastics contained in the fluid to agglomerate, and then can collect and remove the fine particles and the ultrafine particles.

### Solution to Problem

According to an embodiment of the present invention to achieve an above-described object of the present invention, there is provided a method for fine particle agglomeration, the method including: an initial fine particle measuring step of generating fine particle measurement data including a pollution level of fine particles in a purification region and outputting the data to a sound source converting unit, by a fine particle measuring unit; a low frequency and sound pressure data extracting step of extracting a low frequency and sound pressure of a low frequency sound source stored in a storage to be used for agglomeration of fine particles, based on the fine particle measurement data by the sound source converting unit; a sound source converting step of converting an output sound source into the low frequency sound source such that the low frequency sound source has the extracted low frequency and sound pressure data, by the sound source converting unit; and a fine particle agglomeration performing step of causing fine particles to agglomerate by receiving the low frequency sound source and outputting the low frequency sound source as a low frequency sound wave for agglomeration of fine particles, by a low frequency sound wave generating unit.

The sound source converting step may be a step of converting the output sound source into the low frequency sound source to have a low frequency in a range of higher than 0 Hz to 4,000 Hz.

The sound source converting step may be a step of converting the output sound source into the low frequency sound source to have sound pressure in a range of 0 dB to 100 dB.

The fine particle agglomeration performing step may be a step of outputting a low frequency sound wave corresponding to the low frequency sound source by an actuator group including one or more pairs of actuators with each pair of actuators facing each other.

The method for fine particle agglomeration may be configured to further include, after the sound source converting step, a sound source amplifying step of receiving and amplifying the low frequency sound source outputted from the sound source converting unit and then outputting an amplified low frequency sound source to the low frequency sound wave generating unit, by a sound source amplifying unit.

The method for fine particle agglomeration may be configured to further include, after the fine particle agglomeration performing step, a low frequency and sound pressure measuring step of detecting a frequency and sound pressure of the low frequency sound wave outputted corresponding to the low frequency sound source and then transmitting the detected frequency and sound pressure to the sound source converting unit, by the low frequency sound wave measuring unit; a low-frequency-sound-source-related low frequency and sound pressure comparing step of comparing the received low frequency and sound pressure with the extracted low frequency and sound pressure, by the sound source converting unit; and a low frequency sound source feedback adjusting step of adjusting the low frequency sound source to have the extracted low frequency and sound pressure, then returning to the fine particle agglomeration performing step, and re-performing a process procedure, by the sound source converting unit, when the received low frequency and sound pressure do not match to the extracted low frequency and sound pressure.

According to another embodiment of the present invention to achieve another above-described object of the present invention, there is provided an apparatus for fine particle agglomeration, the apparatus including: a fine particle measuring unit that measures a pollution level of fine particles in a purification region, generates fine particle measurement data, and outputs the data to a sound source converting unit; the sound source converting unit that receives the fine particle measurement data, then extracts an output sound source, converts the output sound source into a low frequency sound source having a low frequency and sound pressure for agglomeration of fine particles, and outputs the low frequency sound source; and one or more low frequency sound wave generating units that reproduce and output the low frequency sound source as a low frequency sound wave into a fine particle purification region, the low frequency sound source being outputted from the sound source converting unit.

The sound source converting unit may be configured of a storage that stores the output sound source and low frequency and sound pressure data for agglomeration of fine particles depending on the pollution level of fine particles.

The apparatus for fine particle agglomeration may be configured to further include a sound source amplifying unit that receives before the low frequency sound source is inputted to the low frequency sound wave generating unit, amplifies, and outputs the low frequency sound source outputted from the sound source converting unit.

The low frequency may be in a range of higher than 0 Hz to 4,000 Hz.

The sound pressure may be in a range of 0 dB to 100 dB.

The low frequency sound wave generating unit may be configured of one or more pairs of actuators disposed to face each other in the purification region so as to increase agglomeration efficiency of fine particles by amplifying a low frequency sound wave outputted corresponding to the low frequency sound source.

The apparatus for fine particle agglomeration may further include a low frequency sound wave measuring unit that detects a frequency and sound pressure of the low frequency sound wave and then transmits the detected frequency and sound pressure to the sound source converting unit. The sound source converting unit may be configured to adjust and output the low frequency and sound pressure of the low frequency sound source when the low frequency and the sound pressure do not match.

According to still another embodiment of the present invention to achieve still another above-described object of the present invention, there is provided an apparatus for fine particle agglomeration and removal, the apparatus including: an agglomeration channel part that forms a flow path of a fluid in which fine particles are contained; and a low frequency sound wave generating unit that outputs a low frequency sound wave for agglomeration of the fine particles into the agglomeration channel part. The agglomeration channel part is configured of one or more unit agglomeration channels including an agglomeration chamber having an agglomerate discharge channel formed at a lower part thereof and a Y-shaped channel forming portion by which an internal region of the agglomeration chamber is formed into a Y-shaped channel.

The agglomeration chambers may have a hopper structure in which a fluid inlet is formed at one side of an upper part thereof, a fluid outlet is formed at the other side of the fluid inlet, the agglomerate discharge channel is formed in the lower part thereof, and the upper part thereof is covered with the Y-shaped channel forming portion.

The Y-shaped channel forming portion may be configured to have a regular T-shaped sectional structure in which a lower end portion of the Y-shaped channel forming portion projects downward from an inside of each of the agglomeration chambers to form a Y-shaped channel in the inside of each of the agglomeration chambers.

The low frequency sound wave generating unit may be configured to include one or more pairs of actuators disposed to face each other of each pair thereof in the agglomeration channel part.

The actuators may be disposed to face each other at a lower location of the lower end portion of a T-shaped section of the Y-shaped channel forming portion of the agglomeration chamber.

The apparatus for fine particle agglomeration and removal may be configured to further include a fine particle measuring unit that measures a fluid made of a gas or a liquid flowing into the agglomeration channel part and generates and outputs fine particle measurement data.

The apparatus for fine particle agglomeration and removal may be configured to further include a control unit that generates a low frequency sound source having a frequency and sound pressure for agglomeration of fine particles in response to the fine particle measurement data, and outputs the generated low frequency sound source to the low frequency sound wave generating unit.

The control unit may be configured of a storage that stores frequency and sound pressure data for each fine particle pollution level for agglomeration of fine particles.

The frequency may be in a range of 20 Hz to 20 kHz.

The sound pressure may be in a range of 0 dB to 100 dB.

The apparatus for fine particle agglomeration and removal may further include: a measurement sensor unit that detects a frequency and sound pressure of a low frequency sound wave in the agglomeration channel part and then transmits the detected frequency and sound pressure to the control unit; and a residual fine particle measuring unit that measures residual fine particles contained in a fluid which is discharged from the agglomeration channel part and that transmits residual fine particle measurement information data to the control unit. The control unit may be configured to perform low frequency sound source feedback control adjustment of receiving the frequency and the sound pressure of low frequency sound wave in the agglomeration channel part and the residual fine particle measurement information, quickly shifting the frequency and the sound pressure of the low frequency sound source, and outputting the shifted frequency and sound pressure.

The apparatus for fine particle agglomeration and removal may be configured to further include a collection unit that collects agglomerated fine particle agglomerates which agglomerate in the agglomeration channel part.

According to still another embodiment of the present invention to achieve still another above-described object of the present invention, there is provided a method for intra-fluid fine particle agglomeration and removal, the method including: an initial fine particle measuring step of generating intra-fluid fine particle measurement data of a fluid as a purification target and outputting the fine particle measurement data to a control unit by a fine particle measuring unit; a sound source generating step of generating and outputting a low frequency sound source by extracting a frequency and sound pressure of the low frequency sound source stored in a storage to be used for agglomeration of fine particles, based on the fine particle measurement data by the control unit; a fine particle agglomeration performing step of causing fine particles to agglomerate by outputting a low frequency sound wave corresponding to the low frequency sound source into the agglomeration chamber, by the low frequency sound wave generating unit; and an agglomerated fine particle collecting step of removing agglomerated fine particle agglomerates by using a collection unit.

The sound source generating step may be a step of generating the low frequency sound source to have a frequency in a range of 20 Hz to 20 kHz.

The sound source generating step may be a step of generating the low frequency sound source to have sound pressure in a range of 0 dB to 100 dB.

The fine particle agglomeration performing step may be a step of outputting the low frequency sound wave by one or more pairs of actuators disposed to face each other of each pair thereof in agglomeration chambers of the agglomeration channel part.

The fine particle agglomeration performing step may be a step of outputting the low frequency sound wave while facing each other at a lower location of a lower end portion of a T-shaped section of a Y-shaped channel forming portion of each of the agglomeration chambers.

The method for intra-fluid fine particle agglomeration and removal may be configured to further include, after the sound source generating step, a sound source amplifying step of receiving and amplifying the low frequency sound source outputted from the control unit and then outputting an amplified low frequency sound source to the low frequency sound wave generating unit, by a sound source amplifying unit.

The method for intra-fluid fine particle agglomeration and removal may be configured to further include a feedback control data measuring step of outputting, to the control unit, feedback control data generated by measuring a frequency and sound pressure of a low frequency sound wave in each of the agglomeration chambers or residual fine particles in a discharged fluid for feedback control of a low frequency sound source; a fine particle removal efficiency reach determining step of determining whether or not a fine particle removal objective is achieved by using the received feedback control data, by the control unit; and a low frequency sound source feedback adjusting step of re-generating and outputting a low frequency sound source by adjusting a frequency and sound pressure of a low frequency sound source to increase agglomeration efficiency when target efficiency of fine particle removal is not reached based on a determination result of the fine particle removal efficiency reach determining step.

The method for intra-fluid fine particle agglomeration and removal may further include, when the target efficiency of the fine particle removal is reached based on the determination result of the fine particle removal efficiency reach determining step, a fine particle removal operation end determining step of returning to the fine particle agglomeration performing step and re-performing a process procedure in a case where a fine particle removing operation is not ended, and of ending the process procedure in a case where the fine particle removal operation is ended.

### Advantageous Effects of Invention

According to embodiments of the present invention described above, an apparatus and a method for fine particle agglomeration have an effect in that fine particles such as ultrafine dust, nanoplastics, fine dust, or microplastics in a medium such as air or a fluid can be removed at low costs by causing fine particles contained in air or a fluid to agglomerate using a low frequency sound wave, without using an expensive filter or a water treatment agent harmful to the environment.

In addition, according to the embodiments of the present invention described above, the apparatus and the method for fine particle agglomeration do not use a toxic material such as a water treatment agent harmful to the environment to remove fine particles, thus having an effect in that the fine particles can be easily removed without an adverse effect on the environment and a human body during removal of fine particles.

In addition, according to other embodiments of the present invention described above, an apparatus and a method for fine particle agglomeration and removal have an effect in that fine particles such as ultrafine dust, nanoplastics, fine dust, or microplastics in a medium such as air or a fluid can be effectively removed at low costs, without using an expensive filter or a water treatment agent harmful to the environment.

In addition, according to the embodiments of the present invention described above, the apparatus and the method for fine particle agglomeration and removal do not use a toxic material such as a water treatment agent harmful to the environment to remove fine particles, thus having an effect in that the fine particles can be easily removed without an adverse effect on the environment and a human body during removal of fine particles.

### BRIEF DESCRIPTION OF DRAWINGS

FIG. 1 is a flowchart illustrating a process procedure of a method for fine particle agglomeration according to an embodiment of the present invention.

FIG. 2 is a functional block diagram of an apparatus 100 for fine particle agglomeration which performs agglomeration of fine particles according to another embodiment of the present invention.

FIG. 3 is a view illustrating an installation state of the apparatus 100 for fine particle agglomeration which performs agglomeration and removal of fine particles in a fluid such as drinking water or domestic water according to the embodiment of the present invention.

FIG. 4 is a view illustrating an installation state of the apparatus 100 for fine particle agglomeration which is installed indoors to perform agglomeration and removal of fine particles in the air according to the embodiment of the present invention.

FIG. 5 is a view illustrating agglomeration of fine particles with a low frequency sound wave outputted corresponding to a low frequency sound source for agglomeration of the fine particles according to the embodiment of the present invention.

FIG. 6 is a view illustrating a mechanism of causing fine particles to agglomerate with the low frequency sound wave outputted corresponding to the low frequency sound source for agglomeration of the fine particles according to the embodiment of the present invention.

FIG. 7 is a view illustrating an overlap of low frequency sound waves generated from low frequency sound sources for agglomeration of fine particles by a low frequency sound wave generating unit configured of multiple actuators including pairs of actuators according to the embodiment of the present invention.

FIG. 8 is a graph illustrating a difference between intensity of low frequency sound waves outputted from an actuator group configured of pairs of actuators facing each other for agglomeration of fine particles according to the embodiment of the present invention and intensity of a low frequency sound wave outputted from a single actuator.

FIG. 9 is a graph illustrating fine dust concentration measurement values obtained from a case of not reproducing a low frequency sound source and cases of shifting and outputting a low frequency and sound pressure of a low frequency sound source.

FIG. 10 is a functional block diagram of an apparatus 200 for fine particle agglomeration and removal which performs agglomeration of fine particles according to still another embodiment of the present invention.

FIG. 11 is a view illustrating a detailed configuration of a unit agglomeration channel 261 in FIG. 10.

FIG. 12 is a view illustrating a mechanism of causing fine particles to agglomerate with a low frequency sound wave outputted corresponding to a low frequency sound source for agglomeration of the fine particles according to the embodiment of the present invention.

FIG. 13 is a view schematically illustrating an installation state of a low frequency sound wave generating unit 240 configured of multiple actuators including a pair of actuators 240a and 240b facing each other according to the embodiment of the present invention.

FIG. 14 is a view illustrating an overlap of low frequency sound waves generated from low frequency sound sources for agglomeration of fine particles by the low frequency sound wave generating unit configured of the multiple actuators including pairs of according to the embodiment of the present invention

FIG. 15 is a graph illustrating a difference between intensity of sound waves outputted from an actuator group configured of pairs of actuators facing each other for agglomeration of fine particles according to the embodiment of the present invention and intensity of a sound wave due to vibration outputted from a single actuator.

FIG. 16 is a view illustrating sound pressure distributions depending on a separated distance d between the actuators 240a and 240b as a sound wave generating unit according to the embodiment of the present invention.

FIG. 17 is a graph illustrating fine dust concentration measurement values obtained from a case where a low frequency sound source is not reproduced and cases where a frequency and sound pressure of a low frequency sound source are shifted and outputted.

FIG. 18 is a flowchart illustrating a process procedure of a method for intra-fluid fine particle agglomeration and removal according to still another embodiment of the present invention.

### DESCRIPTION OF EMBODIMENTS

Hereinafter, the present invention will be described with reference to the accompanying drawings. However, the present invention can be realized as various different examples, thus is not limited to embodiments described here. Besides, a part unrelated to the description is omitted from the drawings in order to clearly illustrate the present invention, and similar reference signs are assigned to similar parts through the entire specification.

In the entire specification, a case where a certain part “is connected to (accesses, is in contact with, or is coupled to)” another part means not only a case where the parts are “directly connected” to each other, but also a case where the parts are “indirectly connected” to each other with another member interposed therebetween. In addition, a case where a certain part “comprises” a certain configurational element means that another configurational element is not excluded but can be further comprised, unless specifically described otherwise.

Terms used in this specification are only used to describe a specific embodiment and are not intentionally used to limit the present invention. A singular form of a word also includes a meaning of its plural form, unless obviously implied otherwise in context. In this specification, words such as “to comprise” or “to include” are to be construed to specify that a feature, a number, a step, an operation, a configurational element, a member, or a combination thereof described in the specification is present and not to exclude presence or a possibility of addition of one or more other features, numbers, steps, operations, configurational elements, members, or combinations thereof in advance.

Hereinafter, embodiments of the present invention will be described in detail with reference to the accompanying drawings.

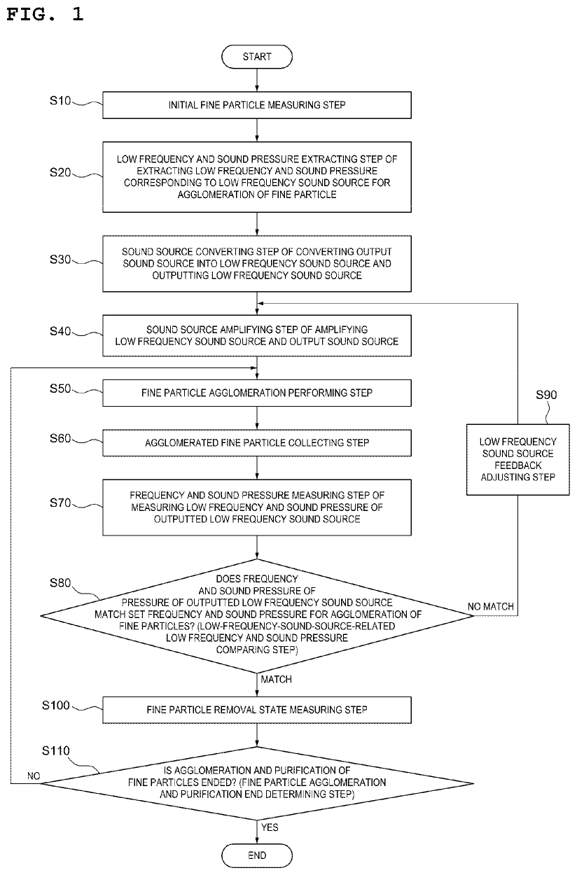

FIG. 1 is a flowchart illustrating a process procedure of a method for fine particle agglomeration according to an embodiment of the present invention.

As illustrated in FIG. 1, in the method for fine particle agglomeration, first, a fine particle measuring unit 110 performs an initial fine particle measuring step S10 of outputting, to a sound source converting unit 120, fine particle measurement data generated by measuring a pollution level of fine particles in a purification region. In this case, the fine particle measurement data can include data of size and concentration of fine particles, indoor temperature, indoor humidity, and an area or volume of a purification region.

The sound source converting unit 120 performs a low frequency and sound pressure data extracting step S20 of extracting low frequencies and sound pressure of an output sound source stored in a storage 121 to be used for agglomeration of fine particles and a low frequency sound source, based on the fine particle measurement data. In this case, the extracted low frequencies and sound pressure are classified depending on a size or concentration of fine dust, indoor temperature, indoor humidity, or a purification region area distribution and then can be structured into a fine particle DB to be stored in a storage 121 in the sound source converting unit 120. In this case, the frequency of the low frequency sound source can be in a range of higher than 0 Hz to 4,000 Hz, the sound pressure of the low frequency sound source can be in a range of 0 dB to 100 dB, and the low frequency and the sound pressure are extracted to correspond to the size or the concentration of fine dust, the indoor temperature, the indoor humidity, or the area of the purification region.

Next, the sound source converting unit 120 performs a sound source converting step S30 of converting the output sound source into the low frequency sound source such that the low frequency sound source has the extracted low frequency and sound pressure data and outputting the low frequency sound source.

Next, when the low frequency sound source or the output sound source need to be amplified, a sound source amplifying step S40 of receiving and amplifying the output sound source or the low frequency sound source outputted after the sound source converting step S30, and then outputting an amplified output sound source or low frequency sound source to the speaker unit or a low frequency sound wave generating unit 140 may be performed.

Next, the low frequency sound wave generating unit 140 performs a fine particle agglomeration performing step S50 of causing fine particles in the purification region to vibrate and agglomerate by receiving the low frequency sound source and outputting the low frequency sound wave. In addition, the fine particle agglomeration performing step S50 can be configured to also reproduce and output the output sound source by the speaker unit 140 such that a user can appreciate music from the output sound source at the same time of outputting the low frequency sound wave.

Subsequently, the collection unit 300 performs an agglomerated fine particle collecting step S60 of collecting and removing fine particle agglomerates having a large size due to agglomeration after convection or inflow of air or a fluid in the purification region.

Besides, after the agglomerated fine particle collecting step S60, in accordance with a preset cycle or a control command of a user, a low frequency sound wave measuring unit 150 can perform a low frequency and sound pressure measuring step S70 of detecting a frequency and sound pressure of the low frequency sound wave outputted corresponding to the low frequency sound source and then transmitting the detected frequency and sound pressure to the sound source converting unit 120.

After the low frequency and sound source measuring step S70 is performed, the sound source converting unit 120 performs a low-frequency-sound-source-related low frequency and sound pressure comparing step S80 of comparing the received low frequency and sound pressure with the extracted low frequency and sound pressure and determining whether or not the received low frequency and sound pressure match the extracted low frequency and sound pressure.

Besides, when the received low frequency and sound pressure do not match the extracted low frequency and sound pressure, the sound source converting unit 120 performs a low frequency sound source feedback adjusting step S90 of adjusting the low frequency sound source to have the extracted low frequency and sound pressure, then returning to the sound source amplifying step S40 or the fine particle agglomeration performing step S50, and re-performing a process procedure.

On the other hand, when the low frequency and the sound pressure of the low frequency sound wave measured by the low frequency sound wave measuring unit 150 match the low frequency and the sound pressure stored in the storage 121 based on a comparison result in the low-frequency-sound-source-related low frequency and sound pressure comparing step S80, the fine particle measuring unit 110 can perform a fine particle removal state measuring step S100 of measuring a fine particle removal state by measuring fine particles in the purification region in accordance with a preset time or a control command of a user and comparing the fine particles with the fine particle measurement data.

Besides, when the fine particle concentration is decreased to be equal to or lower than the preset concentration based on measurement result in the fine particle removal state measuring step S100, or fine particle agglomeration and purification is not ended by determining whether an end criterion of a fine particle agglomeration and purification process, such as whether or not an end control command of a user is input, is satisfied, the process returns to the fine particle agglomeration performing step S50, and the process procedure is re-performed. When the fine particle agglomeration and purification is ended, a fine particle agglomeration and purification end determining step S110 of ending the process procedure is performed.

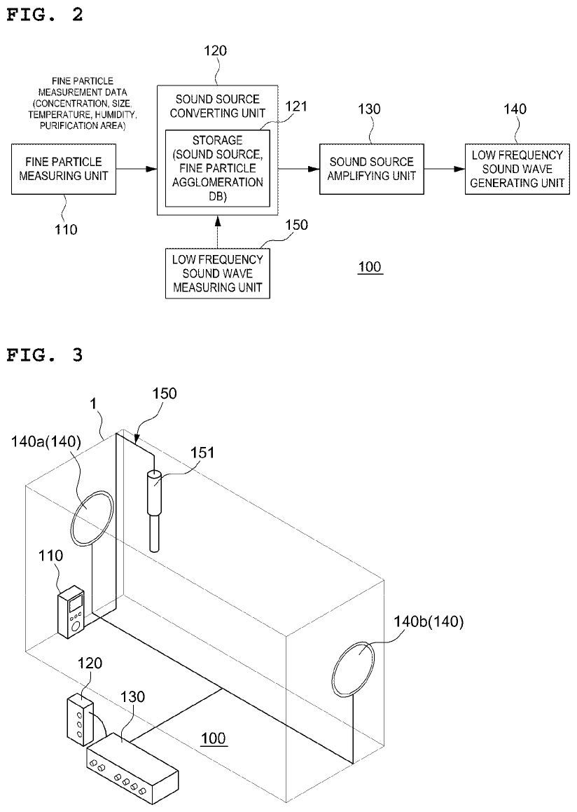

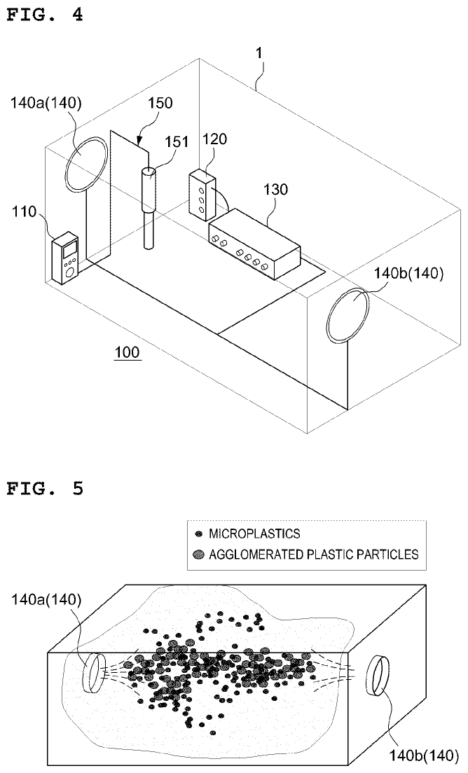

FIG. 2 is a functional block diagram of the apparatus 100 for fine particle agglomeration which performs agglomeration of fine particles according to another embodiment of the present invention to which the method for fine particle agglomeration of the present invention is applied. FIG. 3 is a view illustrating an installation state of the apparatus 100 for fine particle agglomeration which performs agglomeration and removal of fine particles in a fluid such as drinking water or domestic water according to the embodiment of the present invention. FIG. 4 is a view illustrating an installation state of the apparatus 100 for fine particle agglomeration which is installed indoors to perform agglomeration and removal of fine particles in the air according to the embodiment of the present invention.

As illustrated in FIG. 2, the apparatus 100 for fine particle agglomeration can be configured to include a fine particle measuring unit 110 that measures concentration or size of fine particles, temperature, or humidity in a purification region 1 and generates and outputs fine particle measurement data, a sound source converting unit 120 that converts an output sound source into a low frequency sound source for agglomeration of fine particles based on the fine particle measurement data measured by the fine particle measuring unit 110 and outputs the low frequency sound source, a low frequency sound wave generating unit 140 that generates and outputs the low frequency sound source for agglomeration of fine particles, and a collection unit 300 that collects agglomerated fine particle agglomerates.

In addition, the apparatus 100 for fine particle agglomeration can be configured to further include a sound source amplifying unit 130 that amplifies the low frequency sound source outputted from the sound source converting unit 120 and outputs the amplified low frequency sound source, and a speaker unit configured to include one or more speakers that output the output sound source as a sound signal.

The fine particle measuring unit 110 is configured to measure size or concentration of fine particles in a purification region 1, temperature, humidity, or the like in the purification region 1 from which fine particles are caused to agglomerate and are removed, and then to output measured data as fine particle measurement data to the sound source converting unit 120.

The sound source converting unit 120 is configured to receive the fine particle measurement data outputted from the fine particle measuring unit 110, the fine particle measurement data including information of the concentration or size of fine particles, indoor temperature, indoor humidity, and a purification area, then to extract an output sound source, to convert the output sound source into a low frequency sound source having a low frequency and sound pressure for agglomeration of fine particles, and to output the low frequency sound source. The sound source converting unit 120 can be configured to include a storage 121 that stores frequency and sound pressure information of the low frequency sound source for each concentration or size of fine particles, area information of the purification region, program information including functions for conversion of the low frequency sound source, or the like in order to convert the output sound source into the low frequency sound source.

In this case, the low frequency of the low frequency sound source can be in a low frequency range of higher than 0 Hz to 4,000 Hz as a frequency domain of sound that people cannot hear within a range of acoustic wave. Besides, the sound pressure may be in a range of 0 dB to 100 dB.

The sound source amplifying unit 130 is configured to include an amplification elements that amplify an amplitude of the low frequency sound source, thus when needed, amplifies the low frequency sound source outputted from the sound source converting unit 120 and outputs an amplified low frequency sound source.

The low frequency sound waves generating unit 140 is configured to include one or more actuators 140a and 140b which reproduce the low frequency sound source outputted from the sound source converting unit 120 as a low frequency sound wave, receives the low frequency sound source, and then outputs the low frequency sound wave to the purification region 1. In addition, the pair of actuators 140a and 140b can be disposed to face each other in the purification region so as to increase collision efficiency of the fine particles and thereby to increase agglomeration efficiency by overlapping and amplifying the low frequency sound wave outputted corresponding to the low frequency sound source, and multiple pairs of actuators can be disposed depending on an area or volume of the purification region.

The apparatus 100 for fine particle agglomeration of the embodiment of the present invention having the above-described configuration can be configured to further include a sound source amplifying unit 130 that amplifies the output sound source and the low frequency sound source outputted from the sound source converting unit 120, and a low frequency sound wave measuring unit 150 that includes a dB meter 151 having an internally provided dB measuring sensor which measures a frequency and sound pressure of the low frequency sound wave outputted from the low frequency sound wave generating unit 140 and outputs the frequency and the sound source to the sound source converting unit 120.

When the low frequency sound wave measuring unit 150 is provided, the sound source converting unit 120 can be configured to perform a feedback control function of adjusting and outputting the low frequency and sound pressure of the low frequency sound source, in a case where the measured low frequency and sound pressure inputted from the low frequency sound wave measuring unit 150 are compared with a low frequency and sound pressure extracted from a storage 121, and the measured low frequency and sound pressure do not match the extracted low frequency and sound pressure.

When the apparatus 100 for fine particle agglomeration having the above-described configuration is applied to collecting fine particles such as microplastics in a fluid such as drinking water or domestic water, the fine particle measuring unit 110, the low frequency sound wave generating unit 140, and the low frequency sound wave measuring unit 150 which configure the apparatus 100 for fine particle agglomeration can be provided in the purification region 1 such as a water tank in or into which the drinking water or domestic water is stored or flows, as illustrated in FIG. 3.

In addition, when the fine particle measuring unit 110, the sound source converting unit 120, and the sound source amplifying unit 130 are integrally formed in a sealing structure having a waterproof function, the fine particle measuring unit 110, the sound source converting unit 120, and the sound source amplifying unit 130 can be provided to be immersed in a fluid contained in the water tank or the like.

Besides, when the apparatus 100 for fine particle agglomeration having the above-described configuration is applied to collecting fine particles such as microplastics, fine particles, ultrafine dust, or fine dust in the air of a room, the fine particle measuring unit 110, the sound source converting unit 120, the sound source amplifying unit 130, the low frequency sound wave generating unit 140, and the low frequency sound wave measuring unit 150 which configure the apparatus 100 for fine particle agglomeration can all be provided in the room in which a user spends time, the room being as the purification region 1, as illustrated in FIG. 4.

In other words, the apparatus 100 for fine particle agglomeration of the embodiment of the invention of the present application can be used in a fluid or the air to perform complete agglomeration of fine particles in the fluid or the air.

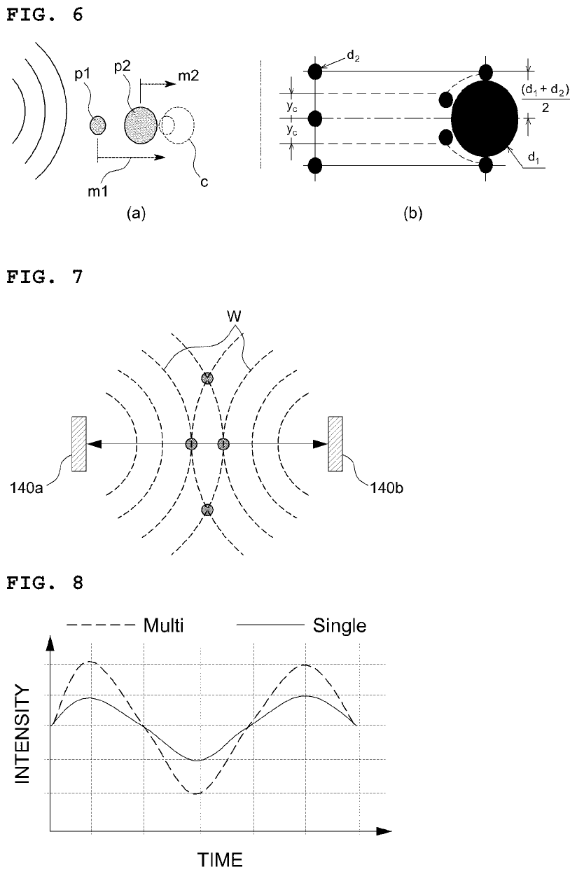

FIG. 5 is a view illustrating agglomeration of fine particles with a low frequency sound wave outputted corresponding to a low frequency sound source for agglomeration of the fine particles according to the embodiment of the present invention. FIG. 6 is a view illustrating a mechanism of causing fine particles to agglomerate with the low frequency sound wave outputted corresponding to the low frequency sound source for agglomeration of the fine particles according to the embodiment of the present invention.

As illustrated in FIGS. 5 and 6, when the low frequency sound wave corresponding to the low frequency sound source is outputted by the low frequency sound wave generating unit 140, fine particles in the purification region 1 vibrate corresponding to a low frequency and sound pressure of the low frequency sound wave, as illustrated in (a) of FIG. 6. In this case, a vibration amplitude m1 of a relatively smaller fine particle becomes greater than a vibration amplitude m2 of a relatively larger fine particle p2. Hence, the relatively smaller fine particle p1 and the relatively larger fine particle p2 collide to each other, and thereby the relatively smaller fine particle p1 and the relatively larger fine particle p2 agglomerate as illustrated in (b) of FIG. 6.

In this case, an agglomeration rate β^{Hy} can be derived by the following Expression 1.

$${β}^{Hy} = \frac{\sqrt{3} {ρ}_{0} {U}_{0}^{2}}{9 μ} \frac{{d}_{1}^{2} {d}_{2}^{2}}{{d}_{1} + {d}_{2}} \qquad [ Expression 1 ]$$

Here, ρ₀ represents density of a medium (for example, gas density), μ represents viscosity of a medium, U₀ represents a velocity amplitude of a wave of the fine particles, d₁ represents a diameter of a relatively smaller fine particle p1, and d₂ represents a diameter of a relatively larger fine particle p2.

FIG. 7 is a view illustrating an overlap of low frequency sound waves generated from the low frequency sound sources for agglomeration of fine particles by the low frequency sound waves generating unit 140 configured of multiple actuators including pairs of actuators according to the embodiment of the present invention. FIG. 8 is a graph illustrating a difference between intensity of low frequency sound waves outputted from an actuator group configured of pairs of actuators facing each other for agglomeration of fine particles according to the embodiment of the present invention and intensity of a low frequency sound wave outputted from a single actuator.

A pair of actuators 140a and 140b which configures the low frequency sound wave generating unit 140 is provided to face each other, and thereby agglomeration efficiency of fine particles can be improved.

Specifically, as illustrated in FIGS. 7 and 8, the pair of actuators 140a and 140b is provided to face each other, and low frequency sound waves w overlap each other, thereby having an increase in intensity. Consequently, the increase in intensity increases velocity amplitudes and impulse during collision of the relatively smaller fine particle p1 and the relatively larger fine particle p2, and thus the agglomeration efficiency increases.

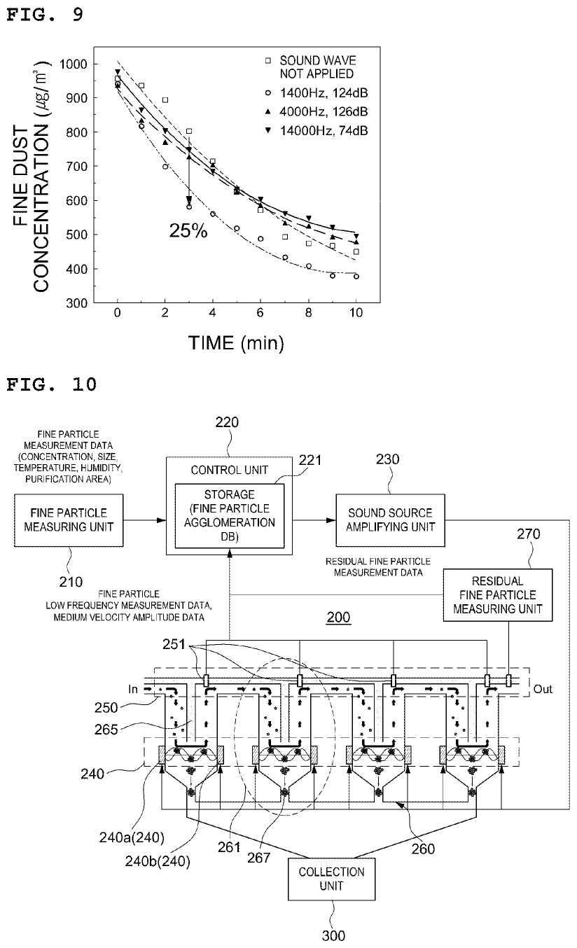

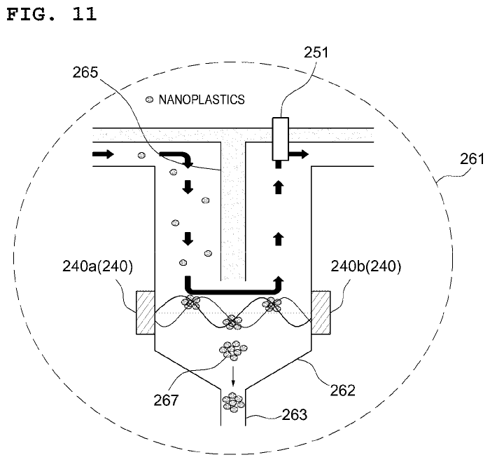

FIG. 9 is a graph illustrating fine dust concentration measurement values obtained from a case of not reproducing a low frequency sound source and cases of shifting and outputting the low frequency and sound pressure of the low frequency sound source.

As illustrated in FIG. 9, purification efficiency of fine particles is found to vary depending on a low frequency and sound pressure of the low frequency sound wave.

FIG. 10 is a functional block diagram of an apparatus 200 for fine particle agglomeration and removal which performs agglomeration of fine particles according to still another embodiment of the present invention. FIG. 11 is a view illustrating a detailed configuration of a unit agglomeration channel 261 in FIG. 10.

As illustrated in FIGS. 10 and 11, the apparatus 200 for fine particle agglomeration and removal can be configured to include a fine particle measuring unit 210 that generates and outputs fine particle measurement data of concentration or size of fine particles, temperature, humidity, or the like in a purification region, a control unit 220 that generates and outputs a low frequency sound source for agglomeration of fine particles based on the fine particle measurement data measured by the fine particle measuring unit 210, a sound source amplifying unit 230 that amplifies and outputs the low frequency sound source outputted from the control unit 220, a low frequency sound wave generating unit 240 that outputs the low frequency sound source as a low frequency sound wave for agglomeration of fine particles, an agglomeration channel part 260 on which the low frequency sound wave generating unit 240 and a measurement sensor unit 250 including measurement sensors 251 are mounted and which are formed to have unit agglomeration channels 261, which are disposed to form a channel to communicate with each other and in which fine particles agglomerate and are removed with vibration of the outputted low frequency sound wave as a fluid such as gas or a liquid containing fine particles flows in the unit agglomeration channels, a residual fine particle measuring unit 270 that measures residual fine particles in a fluid which is discharged from the agglomeration channel part 260 and that outputs measured data to the control unit 220; and a collection unit 300 that collects agglomerated fine particle agglomerates 267 which are discharged from the agglomeration channel part 260.

The fine particle measuring unit 210 is configured to measure the number, size, concentration, a volume, temperature, or the like of fine particles which are contained in a fluid (medium) such as gas or a liquid that flows into the agglomeration channel part 260 from which the fine particles are agglomerated and removed, and then to output measured data as fine particle measurement data to the control unit 220.

The control unit 220 is configured to generate and output a low frequency sound source having a frequency and sound pressure for agglomeration of fine particles after receiving the fine particle measurement data including the number, size, concentration, volume, temperature, or the like outputted from the fine particle measuring unit 210.

The control unit 220 can be configured to include a storage 221 that stores frequency and sound pressure information of the low frequency sound source for each item of fine particle measurement data such as the number, size, concentration, volume, temperature of fine particles, program information including functions for conversion of the low frequency sound source, or the like in order to generate the low frequency sound source.

In this case, the frequency of the low frequency sound source can be in a range of 20 Hz to 20 kHz so as not to be harmful to a human body within a range of acoustic wave, and the sound pressure thereof can be in a range of 0 dB to 100 dB.

In addition, the control unit 220 can be configured to perform low frequency sound source feedback control of shifting the frequency and sound pressure of the low frequency sound source in order to increase fine particle agglomeration efficiency after receiving the low frequency sound wave measurement data in the unit agglomeration channels 261 which is inputted from the measurement sensor unit 250 and the residual fine particle measurement data transmitted from the residual fine particle measuring unit 270.

The sound source amplifying unit 230 is configured to include amplification elements that amplify the low frequency sound source thus when needed, amplifies the low frequency sound source outputted from the control unit 220 and outputs an amplified low frequency sound source.

The low frequency sound wave generating unit 240 generates a low frequency sound wave into the unit agglomeration channels 261 which configure the agglomeration channel part 260 by reproducing the low frequency sound source outputted from the control unit 220 and causes a fluid flowing in the agglomeration channel to vibrate corresponding to a frequency of the low frequency sound wave. In this respect, the low frequency sound wave generating unit 240 is configured to include one or more actuators 240a and 240b which are provided for each of the unit agglomeration channels 261. In addition, the actuators 240a and 240b can be provided as a pair to face each other at the unit agglomeration channel 261 to overlap low frequency sound waves outputted corresponding to the low frequency sound source, in order to increase agglomeration efficiency by increasing a collision force and a collision frequency of the fine particles. Besides, the number of pairs of actuators can be increased depending on an area or volume of the unit agglomeration channel 261.

The measurement sensor unit 250 is configured to measure a frequency and sound pressure of the low frequency sound wave generated in the agglomeration channel part 260 and a velocity amplitude of a fluid flowing in the agglomeration channel part 260 and output measured data to the control unit 220. Consequently, the measurement sensors 251 can be configured to include a phonometer for measuring a frequency, a dB meter for measuring sound pressure, a speedometer for measuring a medium velocity amplitude, or the like.

As illustrated in FIGS. 10 and 11, the agglomeration channel part 260 is configured to include an agglomeration chamber 262 that has a hopper structure in which a fluid inlet 262a is formed at one side of an upper part thereof, a fluid outlet 262b is formed at the other side of the upper part, and an agglomerate discharge channel 263 is formed at a lower part thereof, and one or more unit agglomeration channels 261 configured to have a Y-shaped channel forming portion 265 that has a regular T-shaped sectional structure in which an internal region of the agglomeration chamber 262 forms a Y-shaped channel and that is disposed to cover the upper part of the agglomeration chamber 262.

Besides, the actuators 240a and 240b which configure the low frequency sound wave generating unit 240 are disposed to face each other at an outer side of the agglomeration chamber 262 so as to output low frequency sound waves into the agglomeration chamber 262. In addition, the pair of actuators 240a and 240b disposed to face each other can improve agglomeration efficiency of fine particles by being positioned at a lower end of a T-shaped section of the Y-shaped channel forming portion 265 such that the low frequency sound wave outputted to the inside of the agglomeration chamber 262 is not affected by the Y-shaped channel forming portion 265. In other words, the agglomerated fine particle agglomerates 267 are to be easily discharged by being formed at a lower part of the agglomeration chamber 262 adjacent to the agglomerate discharge channel 263.

The unit agglomeration channel 261 can be formed as a single channel to form the agglomeration channel part 260, or the unit agglomeration channels 261 can be connected to each other to form a serial channel as illustrated in FIG. 10.

The residual fine particle measuring unit 270 is configured to include a residual fine particle measuring instrument 271 disposed in a fluid discharge passage of the agglomeration channel part 260 in order to perform feedback control for agglomeration of fine particles by measuring residual fine particles in a fluid that is discharged from the agglomeration channel part 260, to generate residual fine particle measurement data including the size, concentration, number, or the like of fine particles contained in the fluid that is discharged from the agglomeration channel part 260 and to output the residual fine particle measurement data to the control unit 220.

The collection unit 300 can be configured of purifiers that collect fine particle agglomerates by performing filtration by using a filter such as a HEPA filter or an electrostatic filter or filtration such as separation by a cyclotron.

The apparatus 200 for fine particle agglomeration and removal having the above-described configuration can be installed to collect and remove fine particles such as microplastics in a fluid such as air, drinking water, or domestic water. In other words, the apparatus 200 for fine particle agglomeration and removal of the embodiment of the invention of the present application can be used in a fluid or the air to perform complete agglomeration and collecting of fine particles in the fluid or the air.

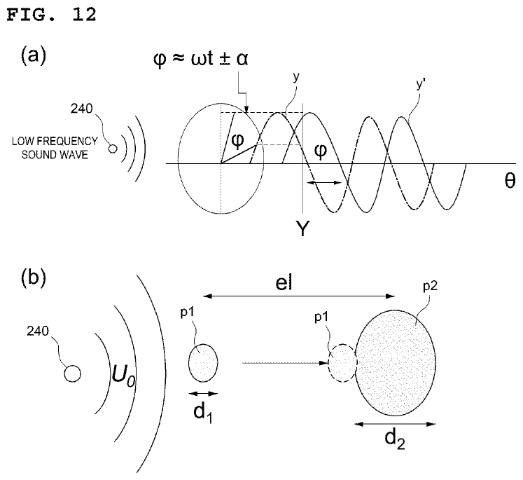

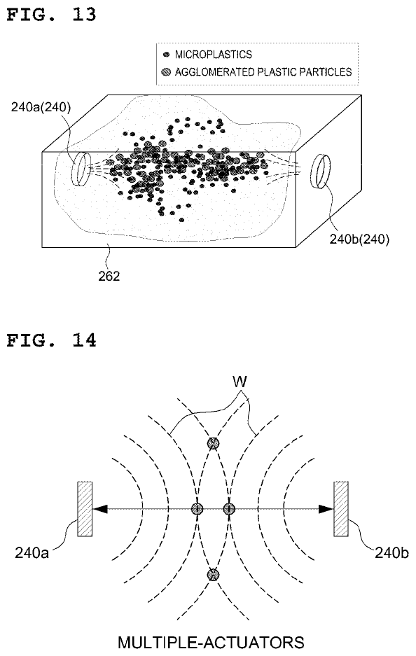

FIG. 12 is a view illustrating a mechanism of causing fine particles to agglomerate with a low frequency sound wave outputted corresponding to the low frequency sound source for agglomeration of the fine particles according to the embodiment of the present invention, (a) of FIG. 12 illustrates the agglomeration of fine particles (p1 and p2) by collision due to vibration of a medium with the low frequency sound wave, and (b) of FIG. 12 illustrates a waveform of vibration due to low frequency sound wave vibration of the medium (fluid) and fine particles p1 and p2.

In FIG. 12, U₀ represents the velocity amplitude of the low frequency sound wave, el represents an effective agglomeration length, y represents a velocity amplitude function of fine particles, d represents a size of a fine particle, y′ represents a velocity amplitude function of a medium, φ(=ωt±α) represents a phase difference between the velocity amplitude of fine particles and the velocity amplitude of the medium, ω represents the angular velocity of the low frequency sound wave, α represents an initial phase of the low frequency sound wave, τ(τ₁, τ₂) represents a fine particle relaxation time as a time till collision between two fine particles, η represents the relative entrainment between two fine particles, Subscript 1 represents smaller fine particles and related variables, and Subscript 2 represents larger fine particles and related variables.

Agglomeration behavior of ultrafine particles in a medium due to wave interference for agglomeration of fine particles which is applied to the present invention is a phenomenon of agglomeration with collision due to a difference in traveling speed between particles in the medium based on an orthokinetic collision mechanism.

The agglomeration behavior of ultrafine particles is developed in conditions of an acoustic wave (Hz) and any sound pressure level (dB), and thereby ultrafine particles having a size of 1 μm or smaller perform agglomeration behavior to coarsen to 10 μm or larger within a short time in conditions of several hertz and several decibels.

With reference to FIG. 12, an agglomeration technology of the apparatus for multi-fine particle agglomeration and removal according to the embodiment of the present invention is obtained by applying orthokinetic collision behavior and is based on behavior agglomeration by surface attraction due to the Van der Waals force when the fine particles collide to each other with a sound wave in a medium such as air.

In this case, fine particle agglomeration efficiency β due to the sound wave in a fluid (medium) can be controlled with variables of a fine particle size d, the velocity amplitude U₀ of the low frequency sound wave, the fine particle relaxation time τ which is the time till collision between two fine particles, and the relative entrainment η between the two fine particles. The following Expression 2 is an expression to calculate the agglomeration efficiency β, and Expression 3 is an expression to calculate the relative entrainment η.

$$β = \frac{{( {d}_{1} + {d}_{2} )}^{2}}{2} {U}_{0} {η}_{12} \qquad [ Expression 2 ]$$

In addition, a velocity difference between fine particles can be calculated by the following Expression 3.

$${η}_{12} = {η}_{1} ∼ {η}_{2} = \frac{1}{\sqrt{1 + {( ω {τ}_{1} )}^{2}}} - \frac{1}{\sqrt{1 + {( ω {τ}_{2} )}^{2}}} \qquad [ Expression 3 ]$$

As illustrated in FIG. 12, when the low frequency sound wave corresponding to the low frequency sound source is outputted by the low frequency sound wave generating unit 240, the fine particles p1 and p2 in the unit agglomeration channel 261 vibrate in response to the frequency and the sound pressure of the low frequency sound wave in the medium, as illustrated in (a) of FIG. 12.

In this case, a vibration amplitude of a relatively smaller fine particle p1 becomes greater than a vibration amplitude of a relatively larger fine particle p2 to cause a difference in traveling distance between the fine particles. Hence, the relatively smaller fine particle p1 and the relatively larger fine particle p2 collide to each other, and thereby the relatively smaller fine particle p1 and the relatively larger fine particle p2 agglomerate by the Van der Waals force to form the fine particle agglomerates 267 and then are discharged through the agglomerate discharge channel 263 to be removed by the collection unit 300. Besides, since the frequency and the sound pressure of the low frequency sound source are controlled, and thereby the agglomeration efficiency β can be adjusted by applying Expression 2, feedback low frequency sound source control for improving the agglomeration efficiency can be performed.

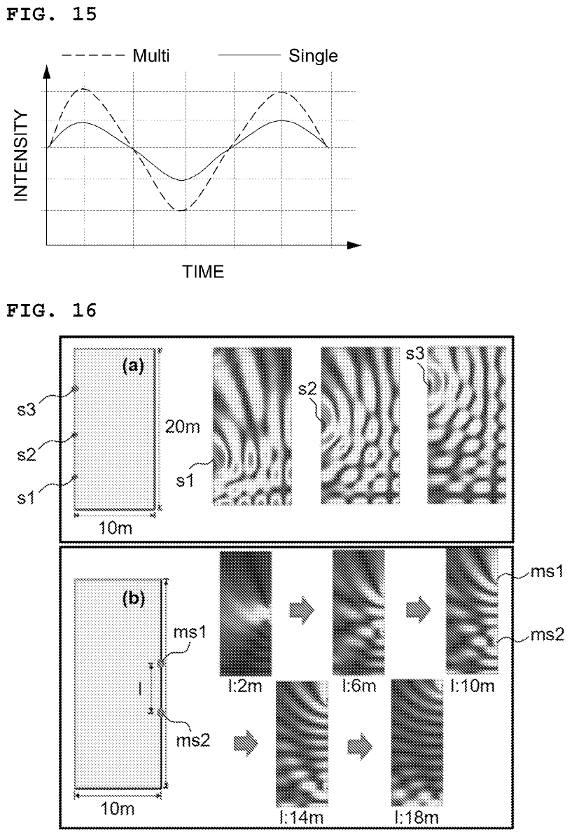

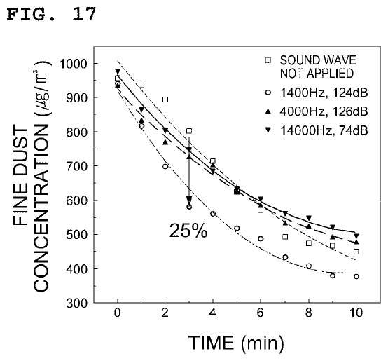

FIG. 13 is a view illustrating agglomeration of fine particles due to output vibration of the low frequency sound source for agglomeration of the fine particles according to the embodiment of the present invention. FIG. 14 is a view illustrating an overlap of low frequency sound waves generated from low frequency sound sources for agglomeration of fine particles by the low frequency sound wave generating unit 240 configured of the multiple actuators including pairs of according to the embodiment of the present invention. FIG. 15 is a graph illustrating a difference between intensity of low frequency sound waves outputted from an actuator group configured of pairs of actuators facing each other and intensity of a low frequency sound wave outputted from a single actuator for agglomeration of fine particles according to the embodiment of the present invention.

The pair of actuators 240a and 240b which configures the low frequency sound wave generating unit 240 is provided to face each other, and thereby agglomeration efficiency of fine particles can be improved.

Specifically, as illustrated in FIGS. 13 to 15, the pair of actuators 240a and 240b is provided to face each other, and low frequency sound waves w overlap each other, thereby having an increase in intensity. Consequently, the increase in intensity increases velocity amplitudes and impulse during collision of the relatively smaller fine particle p1 and the relatively larger fine particle p2, and thus the agglomeration efficiency increases.

FIG. 16 illustrates experimental data showing sound pressure distributions depending on locations of the actuators 240a and 240b as the sound wave generating unit according to the embodiment of the present invention. FIG. 17 is a graph illustrating fine dust concentration measurement values obtained from a case where the low frequency sound source is not reproduced and cases where the frequency and the sound pressure of the low frequency sound source are shifted and outputted.

(a) of FIG. 16 is a view illustrating sound pressure distributions in the agglomeration chamber 262 for respective installation locations (s1, s2, and s3) of the low frequency sound wave generating unit 240 including one actuator as a single source, and (b) of FIG. 16 is a view illustrating sound pressure distributions for respective separated distances 1 between two low frequency sound wave sources (ms1 and ms2) which are two actuators as multiple actuators.

Besides, FIG. 17 shows that removal efficiency of fine dust is high when the sound pressure is high.

This experimental data shows that a wave condition more advantageous to collision and agglomeration of particles is obtained when one or more actuators are located to face each other to increase the sound pressure, compared to a case where the low frequency sound wave generating unit 240 includes one actuator.

FIG. 17 is a graph illustrating fine dust concentration measurement values obtained from a case where the low frequency sound source is not reproduced and cases where the frequency and the sound pressure of the low frequency sound source are shifted and outputted.

As illustrated in FIG. 17, purification efficiency of fine particles is found to vary depending on a frequency and sound pressure of the low frequency sound wave.

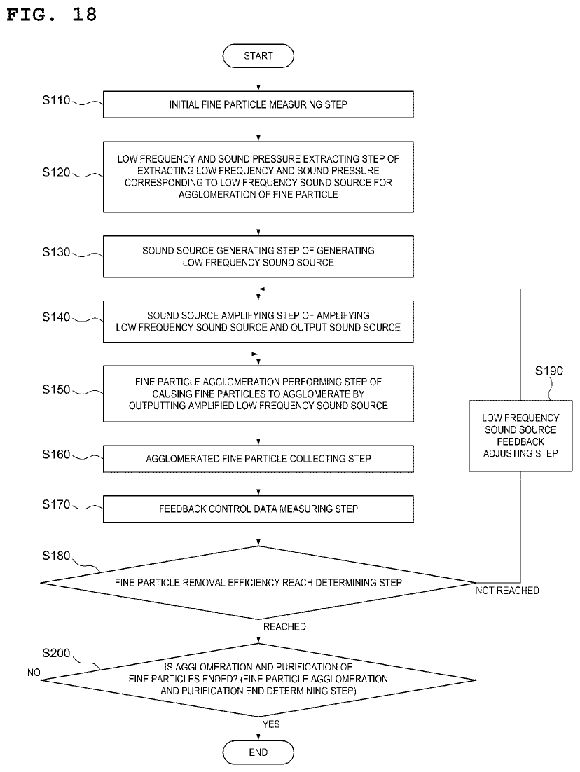

FIG. 18 is a flowchart illustrating a process procedure of a method for fine particle agglomeration and removal according to still another embodiment of the present invention.

As illustrated in FIG. 18, in the method for fine particle agglomeration and removal, the fine particle measuring unit 210 performs an initial fine particle measuring step S110 of outputting, to the control unit 220, fine particle measurement data generated by measuring a pollution level of fine particles in the agglomeration channel part 260. In this case, the fine particle measurement data can include data of the number, size, or concentration of fine particles, temperature or humidity of a fluid (medium), or an area or a volume of a purification region in which the agglomeration channel part 260 is installed.

The control unit 220 performs a frequency and sound pressure data extracting step S120 of extracting frequencies and sound pressure of a low frequency sound source stored in the storage 221 to be used for agglomeration of fine particles, based on the fine particle measurement data. In this case, the extracted frequencies and sound pressure are classified depending on the number, size, or concentration of fine dust, temperature or humidity of a fluid (medium), or an area or volume distribution of a purification region in which the agglomeration channel part 260 is installed, and then the extracted frequencies and sound pressure can be structured into a fine particle DB to be stored in the storage 221 in the control unit 220. In this case, the frequency of the low frequency sound source can be in a range of 20 Hz to 20 kHz, the sound pressure thereof can be in a range of 0 dB to 100 dB, and the frequency and the sound pressure can be extracted to correspond to the size or concentration of fine dust, the room temperature, the indoor humidity, or the area or volume of the purification region.

Next, the control unit 220 performs a sound source generating step S130 of generating and outputting the low frequency sound source having the extracted frequency and sound pressure data.

Next, when the low frequency sound source needs to be amplified, a sound source amplifying step S140 of receiving and amplifying the low frequency sound source outputted after the sound source generating step S130, and then outputting an amplified low frequency sound source to the low frequency sound wave generating unit 240 may be performed.

Next, the low frequency sound wave generating unit 240 performs a fine particle agglomeration performing step S150 of causing fine particles contained in a fluid flowing in the purification region or the agglomeration channel part 260 to vibrate and agglomerate by receiving the low frequency sound source and outputting the low frequency sound wave into the agglomeration chambers 262.

Subsequently, the collection unit 300 performs an agglomerated fine particle collecting step S160 of collecting and removing fine particle agglomerates 267 through the collection unit 300, the fine particle agglomerates having a large size due to agglomeration after convection or inflow of air or a fluid in the unit agglomeration channel 261.

Besides, after the agglomerated fine particle collecting step S160, in accordance with a preset cycle or a control command of a user, a feedback control measuring step S170 of detecting a frequency and sound pressure of the low frequency sound wave outputted in response to the low frequency sound source by the measurement sensor unit 250 and then transmitting the detected frequency and sound pressure to the control unit 220, and detecting the number, concentration, size, or the like of fine particles contained in a fluid which is discharged, by the residual fine particle measuring unit 270 and transmitting detection data to the control unit 220 can be performed.

When the feedback control measuring step S170 is performed, the control unit 220 performs a fine particle removal efficiency reach determining step S180 of determining whether or not the received frequency and sound pressure match the extracted frequency and sound pressure by comparison thereof, calculating fine particle removal efficiency, and determining whether or not the fine particle removal efficiency reaches a target value.

When the fine particle removal efficiency does not reach the target value based on the determination result in the fine particle removal efficiency determining step S180, the control unit 220 performs a low frequency sound source feedback adjusting step S190 of re-generating a low frequency sound source by deriving a frequency and sound pressure which increases fine particle agglomeration efficiency by applying Expression 2 and Expression 3.

Besides, when the fine particle removal efficiency reaches the target value based on the determination result of the fine particle removal efficiency reach determining step S180, the control unit 220 performs a fine particle agglomeration and purification end determining step S200 of determining whether or not a fine particle removal operation is ended. When the operation is not ended, the control unit returns to the fine particle agglomeration performing step S150 and re-performs the process procedure. When the operation is ended, the control unit ends a fine particle agglomeration and purification operation.

The technical ideas of the present invention described above are described specifically in the preferred embodiments; however, note that the embodiments are provided for the description and are not provided to limit the present invention thereto. In addition, it is possible for a person of ordinary knowledge in the technical field of the present invention to realize various embodiments within the scope of the technical ideas of the present invention. Consequently, an actual scope of technical protection of the present invention is to be determined based on technical ideas of the accompanying claims.

### REFERENCE SIGNS LIST

1: Purification Target Region
100: Apparatus for Intra-Fluid Fine Particle Agglomeration
110: Fine Particle Measuring Unit
120: Sound Source Converting Unit
121: Storage
130: Sound Source Amplifying Unit
140: Low Frequency Sound Wave Generating Unit
140a, 140b: Actuator
150: Low Frequency Sound Wave Measuring Unit
151: dB Meter
200: Apparatus for Intra-Fluid Fine Particle
Agglomeration and Removal
210: Fine Particle Measuring Unit
220: Control Unit
221: Storage
230: Sound Source Amplifying Unit
240: Low Frequency Sound Wave Generating Unit
240a, 240b: Actuator
250: Measurement Sensor Unit
251: Measurement Sensor
260: Agglomeration Channel Part
261: Unit Agglomeration Channel
262: Agglomeration Chamber
262a: Fluid Inlet
262b: Fluid Outlet
263: Agglomerate Discharge Channel
265: Y-Shaped Channel Forming Portion
267: Fine Particle Agglomerate
270: Residual Fine Particle Measuring Unit
300: Collection Unit
x: Fine Particle Vibration Amplitude
U₀: Velocity Amplitude of Low Frequency Sound Wave
τ: Fine Particle Relaxation Time-Time Till Collision
η: Relative Entrainment between Two Fine Particles

1. A method for fine particle agglomeration, comprising:
an initial fine particle measuring step of generating fine particle measurement data including a pollution level of fine particles in a purification region and outputting the data to a sound source converting unit, by a fine particle measuring unit;
a low frequency and sound pressure data extracting step of extracting a low frequency and sound pressure of a low frequency sound source stored in a storage to be used for agglomeration of fine particles, based on the fine particle measurement data, by the sound source converting unit;
a sound source converting step of converting an output sound source into the low frequency sound source such that the low frequency sound source has the extracted low frequency and sound pressure data, by the sound source converting unit; and
a fine particle agglomeration performing step of causing fine particles to agglomerate by receiving the low frequency sound source and outputting the low frequency sound source as a low frequency sound wave for agglomeration of fine particles, by a low frequency sound wave generating unit.

2. The method for fine particle agglomeration according to claim 1,
wherein the sound source converting step is a step of converting the output sound source into the low frequency sound source to have a low frequency in a range of higher than 0 Hz to 4,000 Hz.

3. The method for fine particle agglomeration according to claim 1,
wherein the sound source converting step is a step of converting the output sound source into the low frequency sound source to have sound pressure in a range of 0 dB to 100 dB.

4. The method for fine particle agglomeration according to claim 1,
wherein the fine particle agglomeration performing step is a step of outputting a low frequency sound wave corresponding to the low frequency sound source by an actuator group including one or more pairs of actuators with each pair of actuators facing each other.

5. The method for fine particle agglomeration according to claim 1, further comprising:
after the sound source converting step, a sound source amplifying step of receiving and amplifying the low frequency sound source outputted from the sound source converting unit, and then outputting an amplified low frequency sound source to the low frequency sound wave generating unit, by a sound source amplifying unit.

6. The method for fine particle agglomeration according to claim 1, further comprising:
after the fine particle agglomeration performing step, a low frequency and sound pressure measuring step of detecting a frequency and sound pressure of the low frequency sound wave outputted corresponding to the low frequency sound source and then transmitting the detected frequency and sound pressure to the sound source converting unit, by the low frequency sound wave measuring unit;
a low-frequency-sound-source-related low frequency and sound pressure comparing step of comparing the received low frequency and sound pressure with the extracted low frequency and sound pressure, by the sound source converting unit; and
a low frequency sound source feedback adjusting step of adjusting the low frequency sound source to have the extracted low frequency and sound pressure, then returning to the fine particle agglomeration performing step, and re-performing a process procedure, by the sound source converting unit, when the received low frequency and sound pressure do not match the extracted low frequency and sound pressure.

7. An apparatus for fine particle agglomeration, comprising:
a fine particle measuring unit that measures a pollution level of fine particles in a purification region, generates fine particle measurement data, and outputs the data to a sound source converting unit;
the sound source converting unit that receives the fine particle measurement data, extracts an output sound source, converts the output sound source into a low frequency sound source having a low frequency and sound pressure for agglomeration of fine particles, and outputs the low frequency sound source; and
one or more low frequency sound wave generating units that reproduce and output the low frequency sound source as a low frequency sound wave into a fine particle purification region, the low frequency sound source being outputted from the sound source converting unit.

8. The apparatus for fine particle agglomeration according to claim 7,
wherein the sound source converting unit is configured of a storage that stores the output sound source and low frequency and sound pressure data for agglomeration of fine particles depending on the pollution level of fine particles.

9. The apparatus for fine particle agglomeration according to claim 7, further comprising;
a sound source amplifying unit that receives, amplifies, and outputs the low frequency sound source outputted from the sound source converting unit before the low frequency sound source is inputted to the low frequency sound wave generating unit.

10. The apparatus for fine particle agglomeration according to claim 7,
wherein the low frequency is in a range of higher than 0 Hz to 4,000 Hz.

11. The apparatus for fine particle agglomeration according to claim 7,
wherein the sound pressure is in a range of 0 dB to 100 dB.

12. The apparatus for fine particle agglomeration according to claim 7,
wherein the fine low frequency sound wave generating unit is configured of one or more pairs of actuators disposed to face each other in the purification region so as to increase agglomeration efficiency of fine particles by amplifying a low frequency sound wave outputted corresponding to the low frequency sound source.

13. The apparatus for fine particle agglomeration according to claim 7, further comprising:
a low frequency sound wave measuring unit that detects a frequency and sound pressure of the low frequency sound wave and then transmits the detected frequency and sound pressure to the sound source converting unit,
wherein, when a low frequency and sound pressure of the low frequency sound source do not match the low frequency and the sound pressure, the sound source converting unit is configured to adjust and output the low frequency and sound pressure of the low frequency sound source.
